(19) United States
(12) Patent Application Publication
(10) Pub. No.: US 2026/0104812 A1
(43) Pub. Date: Apr. 16, 2026

(54) Dynamically Determining an Input/Output Path

(71) Applicant: Dell Products L.P., Round Rock, TX (US)

(72) Inventors: Kaushik Gupta, Pune (IN); Anurag Sushil Chandra, Pune (IN); Shiv S. Kumar, Pune (IN)

(21) Appl. No.: 18/913,698

(22) Filed: Oct. 11, 2024

(51) Int. Cl. G06F 3/06

(52) U.S. Cl. CPC G06F 3/0644; G06F 3/0604; G06F 3/0673

(57) ABSTRACT

A system can maintain a mapping between respective data chunks of a group of data chunks and at least one respective storage drive of a group of storage drives that store the respective data chunks. The system can determine respective input/output performance characteristics of the different input/output performance characteristics based on monitoring respective input/output operations of the at least one respective storage drive. The system can, based on receiving a request to perform an input/output operation on a data chunk of the group of data chunks, select a storage drive of the group of storage drives based on the mapping and based on the respective input/output performance characteristics, to produce a selected storage drive. The system can perform the input/output operation on the data chunk using the selected storage drive.

### BACKGROUND

A computer system can store files. In some examples, multiple copies of a file can be stored on multiple storage devices of a computer system.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can store a group of data chunks across a group of storage drives, wherein respective storage drives of the group of storage drives store multiple copies of at least some data chunks of the group of data chunks, and wherein the respective storage drives comprise different input/output performance characteristics. The system can maintain a mapping between respective data chunks of the group of data chunks and at least one respective storage drive of the group of storage drives that store the respective data chunks. The system can determine respective input/output performance characteristics of the different input/output performance characteristics based on monitoring respective input/output operations of the at least one respective storage drive. The system can, based on receiving a request to perform an input/output operation on a data chunk of the group of data chunks, select a storage drive of the group of storage drives based on the mapping and based on the respective input/output performance characteristics, to produce a selected storage drive, wherein the selected storage drive stores the data chunk, and wherein the selected storage drive satisfies a performance criterion among a subset of storage drives of the group of storage drives that stores the data chunk. The system can perform the input/output operation on the data chunk using the selected storage drive.

An example method can comprise maintaining, by a system comprising at least one processor, a mapping between respective data chunks of a group of data chunks and at least one respective storage device of a group of storage devices that stores the respective data chunks. The method can further comprise determining, by the system, respective input/output performance characteristics of respective storage devices of the group of storage devices based on monitoring respective input/output operations of the respective storage devices. The method can further comprise based on receiving a request to perform an input/output operation on a data chunk of the group of data chunks, choosing, by the system, a storage device of the group of storage devices based on the mapping and based on the respective input/output performance characteristics, to produce a selected storage device, wherein the selected storage device stores the data chunk, and wherein the selected storage device satisfies a performance criterion among a subset of storage devices of the group of storage devices that stores the data chunk. The method can further comprise performing, by the system, the input/output operation on the data chunk with the selected storage device.

An example non-transitory computer-readable medium can comprise instructions that, in response to execution, cause a system comprising a processor to perform operations. These operations can comprise maintaining a mapping between respective data chunks and at least one respective storage device of a group of storage devices that stores the respective data chunks. These operations can further comprise determining respective input/output performance characteristics of respective storage devices of the group of storage devices based on monitoring respective input/output operations of the respective storage devices. These operations can further comprise, based on receiving a request to perform an input/output operation on a data chunk of the data chunks, identifying a storage device of the group of storage devices based on the mapping and based on the respective input/output performance characteristics, and wherein the storage device satisfies a performance criterion among a subset of storage devices of the group of storage devices that stores the data chunk. These operations can further comprise performing the input/output operation on the data chunk with the storage device.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate dynamically determining an input/output (I/O) path, in accordance with an embodiment of this disclosure;

FIG. 2 illustrates an example table that stores a mapping between respective file chunks and respective storage devices, and that can facilitate dynamically determining an I/O path, in accordance with an embodiment of this disclosure;

FIG. 3 illustrates an example table that stores a mapping between respective storage locations and respective I/O performances of those storage devices, as well as a ranking of storage devices, and that can facilitate dynamically determining an I/O path, in accordance with an embodiment of this disclosure;

FIG. 4 illustrates an example of selecting a storage device among multiple storage devices for an I/O operation, and that can facilitate dynamically determining an I/O path, in accordance with an embodiment of this disclosure;

FIG. 5 illustrates an example process flow for updating a mapping between respective storage locations and respective I/O performances of those storage devices according to a timer, and that can facilitate dynamically determining an I/O path, in accordance with an embodiment of this disclosure;

FIG. 6 illustrates an example process flow that can facilitate dynamically determining an I/O path, in accordance with an embodiment of this disclosure;

FIG. 7 illustrates another example process flow that can facilitate dynamically determining an I/O path, in accordance with an embodiment of this disclosure;

FIG. 8 illustrates another example process flow that can facilitate dynamically determining an I/O path, in accordance with an embodiment of this disclosure;

FIG. 9 illustrates another example process flow that can facilitate dynamically determining an I/O path, in accordance with an embodiment of this disclosure;

FIG. 10 illustrates another example process flow that can facilitate dynamically determining an I/O path, in accordance with an embodiment of this disclosure; and

FIG. 11 illustrates an example block diagram of a computer operable to execute an embodiment of this disclosure.

### DETAILED DESCRIPTION

### Overview

In some examples, a read/write request directed to a specific drive (sometimes referred to as a storage drive or a storage device) can be slow based on how loaded the drive and the node where the drive exists are. Input/output (I/O) access to a drive can also be slow if the drive is wearing out. When a drive striper stripes data, it can preserve a chunk-distribution data structure (sometimes referred to as a CDDS) which can contain information of the drives a chunk of data is stored to. In some examples, a mapping similar to the following can exist (for a CDSS)

| File-Chunk | Node-Drive-Offset |
|---|---|
| Chunk-0 | N1-D1-128, N2-01-128, N3-D2-128 |
| Chunk-1 | N1-D3-256, N2-D2-256, N3-D1-256 |
| Chunk-2 | N1-D3-512, N2-02-512, N3-D5-512 |

While reading data from a specific drive, reading data from that drive can be slower as compared to other drives. This can relate to factors such as drive performance standards, a layout of data stored on the drive, or queues associated with reading from the drive.

Prior approaches can lack a way to identify a best drive from where to fetch a chunk, or a drive that should be prioritized for writing the next chunk that is to be written to the disk. That is, prior approaches can implement a static drive selection.

According to the present techniques, statistical data can be used to identify which drives are faster than others. This can be used to direct reads or writes to these faster drives. For example, using the above example mapping, if N2-D2 is identified to be faster, chunk-1 and chunk-2 can be fetched from N2-D2-256 and N2-D2-512, respectively.

It can be that read and write statistics are generated, but not in the granularity of drives. A ranking of drives can be created based on average performance time for a recent time period (e.g., the last five minutes).

Read and write statistics can be generated but not in the granularity of drives. We just need a ranking of drives based on the average performance time for the last 5 minutes. When a chunk is expected to be read, the drives that the chunk is available on can be determined, and a drive with a highest rank among those drives (that contain the chunk) can be selected.

In some examples, a statistics timer can update a ranking of drives every N seconds (which can be configurable, such as by a user) based on the average performance.

### Example Architectures, Etc.

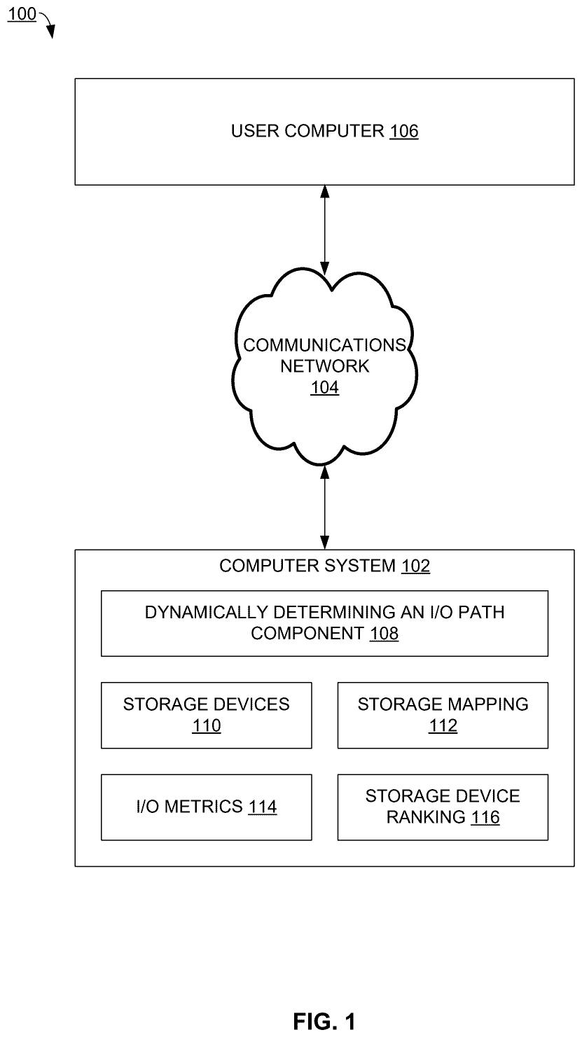

FIG. 1 illustrates an example system architecture 100 that can facilitate dynamically determining an I/O path, in accordance with an embodiment of this disclosure.

System architecture 100 comprises computer system 102, communications network 104, and user computer 106. In turn, computer system 102 comprises dynamically determining an I/O path component 108, storage devices 110, storage mapping 112, I/O metrics 114, and storage device ranking 116.

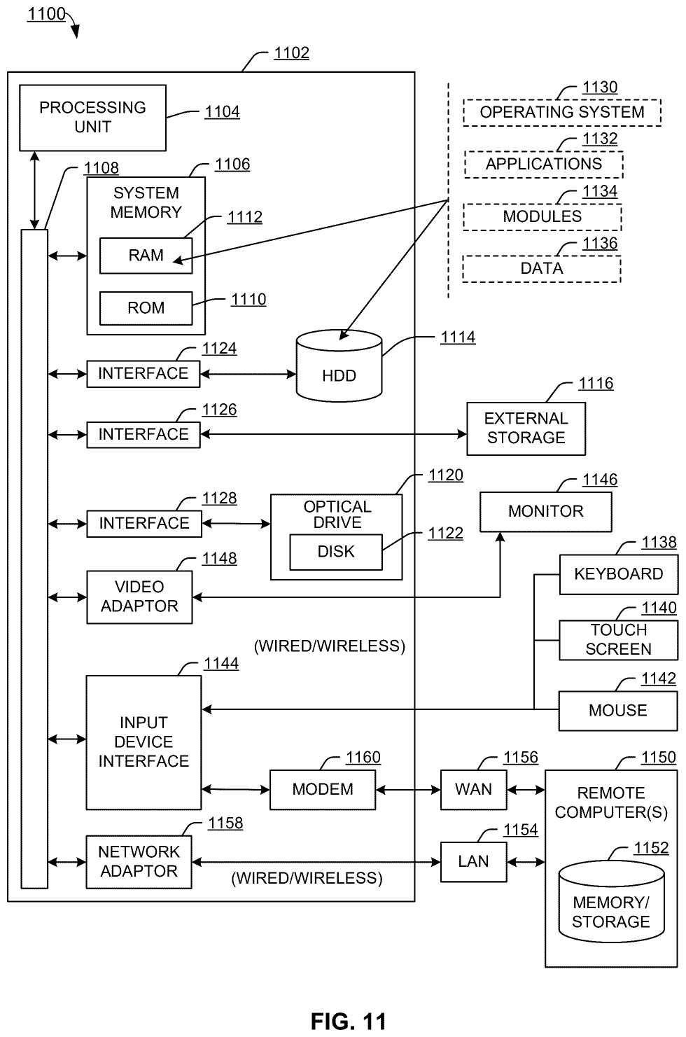

Each of computer system 102 and/or user computer 106 can be implemented with part(s) of computing environment 1100 of FIG. 11. Communications network 104 can comprise a computer communications network, such as the Internet, or an isolated private computer communications network.

User computer 106 can make an I/O request to data (e.g., a file) stored on storage devices 110 (e.g., hard disk drives), via communications network 104. This I/O request can be, for example, a read operation or a write operation. Where it is a read operation, it can be that that the data is stored on multiple storage devices of storage devices 110, and can be read from any of these storage devices. Where it is a write operation, it can be that the data can be stored to one of multiple storage devices of storage devices 110.

Dynamically determining an I/O path component 108 can determine which storage device of storage devices 110 to use to serve the I/O request. This selection of a storage device can be referred to as dynamically determining an I/O path. In some examples, multiple storage devices can be selected (e.g., writing different parts of a file to different storage devices, or reading different parts of a file from different storage devices). Then, the I/O request can be serviced according to the selected storage device.

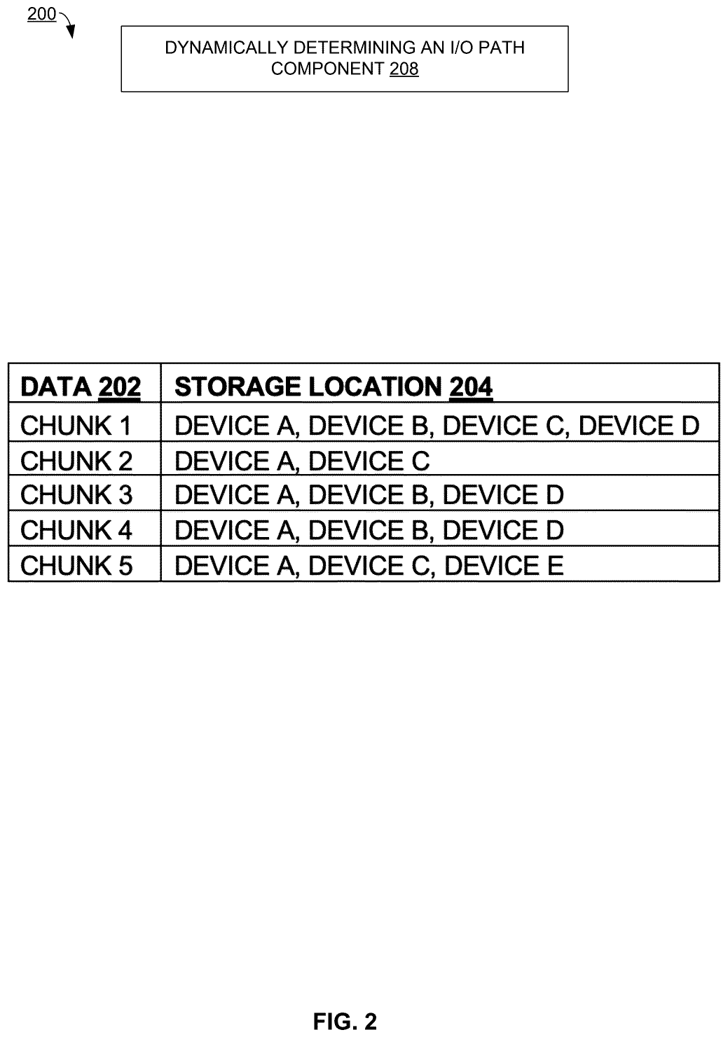

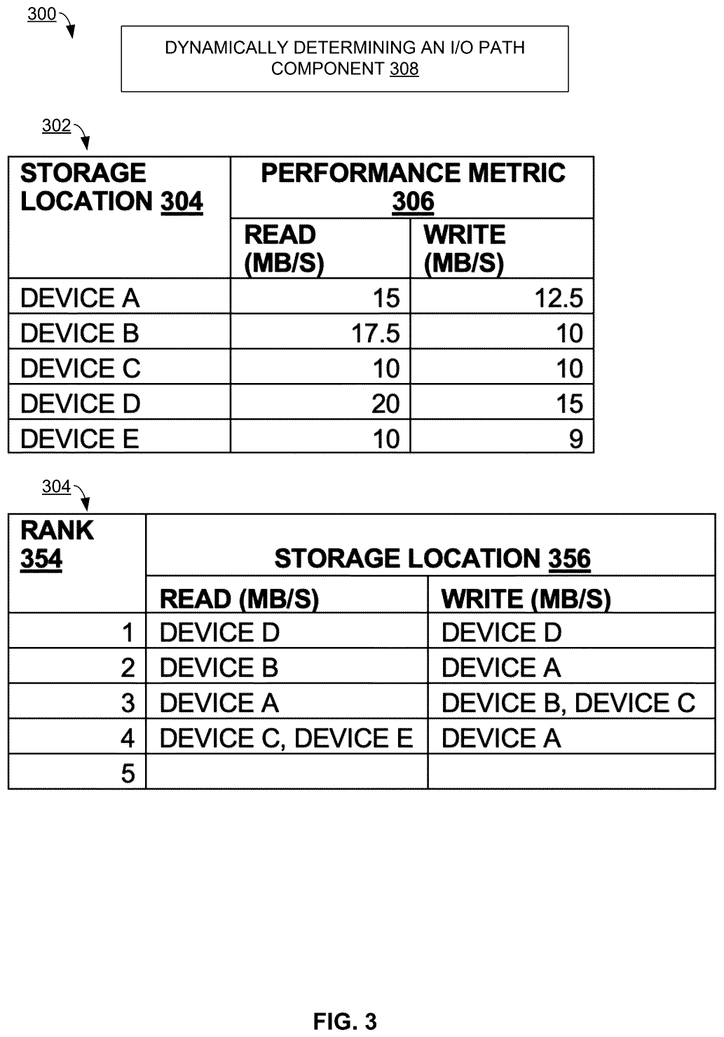

In selecting the selected storage device, dynamically determining an I/O path component 108 can use information in storage mapping 112, I/O metrics 114, and storage device ranking 116. Dynamically determining an I/O path component 108 can use storage mapping 112 (which can be similar to table 200 of FIG. 2) to determine which storage devices of storage devices 110 store particular data. Dynamically determining an I/O path component 108 can use I/O metrics 114 (which can be similar to table 302 of FIG. 3) to determine performance of the storage devices to produce storage device ranking 116. Dynamically determining an I/O path component 108 can use storage device ranking 116 (which can be similar to table 352 of FIG. 3) to select a storage device for the I/O, based on which storage devices store the data.

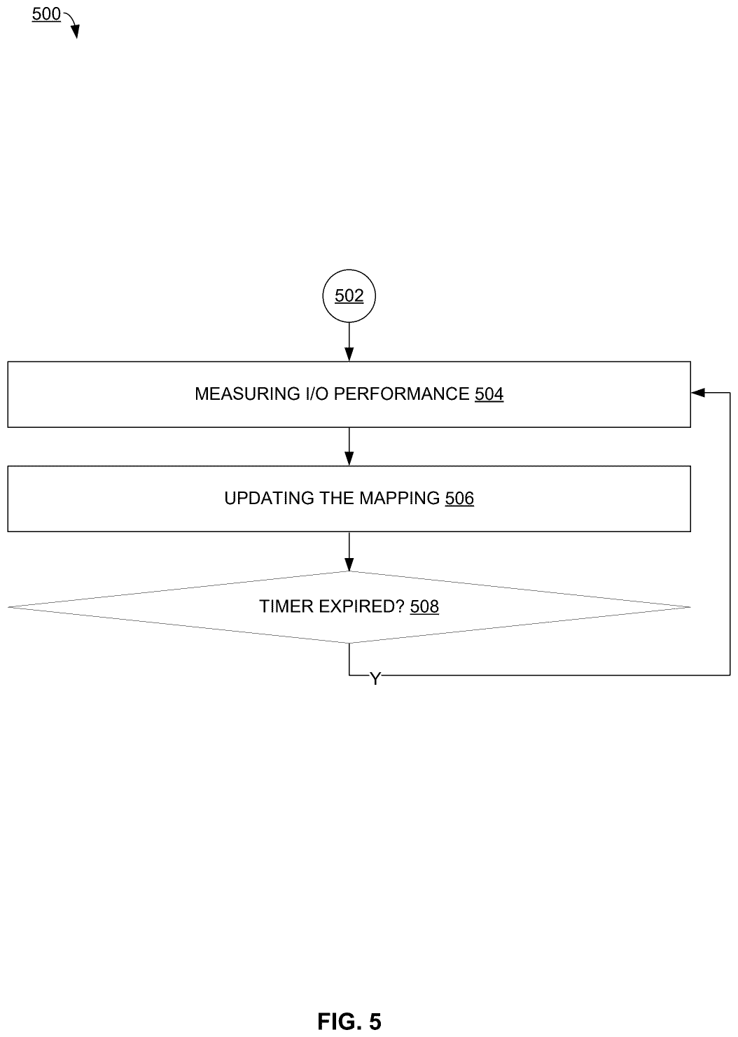

In some examples, dynamically determining an I/O path component 108 can implement part(s) of the process flows of FIGS. 5-10 to facilitate dynamically determining an I/O path.

It can be appreciated that system architecture 100 is one example system architecture for dynamically determining an I/O path, and that there can be other system architectures that facilitate dynamically determining an I/O path.

FIG. 2 illustrates an example table 200 that stores a mapping between respective file chunks and respective storage devices, and that can facilitate dynamically determining an I/O path, in accordance with an embodiment of this disclosure. In some examples, part(s) of table 200 can be implemented by part(s) of system architecture 100 of FIG. 1 to facilitate dynamically determining an I/O path.

Table 200 comprises data 202, storage location 204, and dynamically determining an I/O path component 208 (which can be similar to dynamically determining an I/O path component 108 of FIG. 1).

The information in table 200 can be used to determine which storage devices (as identified in storage location 204) store particular data, in selecting a storage device with which to fulfill an I/O request.

FIG. 3 illustrates an example table 300 that stores a mapping between respective storage locations and respective I/O performances of those storage devices, as well as a ranking of storage devices, and that can facilitate dynamically determining an I/O path, in accordance with an embodiment of this disclosure. In some examples, part(s) of table 300 can be implemented by part(s) of system architecture 100 of FIG. 1 to facilitate dynamically determining an I/O path.

Table 300 comprises table 302 (which comprises storage location 304 and performance metric 306 (which can measure I/O speeds in megabytes per second (MB/s)), table 352 (which rank 354 and storage location 356), and dynamically determining an I/O path component 208 (which can be similar to dynamically determining an I/O path component 108 of FIG. 1).

Table 302 can illustrate which storage devices have which performance metrics (e.g., average speed to perform read I/O and/or write I/O). These metrics can differ between drives, even drives of the same make and model. Table 352 can illustrate a ranking of the storage devices of table 302, based on the performance metrics (e.g., faster devices are ranked higher). In some examples, there can be multiple rankings, such as one ranking for read I/O and another ranking for write I/O.

The information in table 352 can be used to select a storage device with which to fulfill an I/O request (e.g., to select the fastest storage device for a particular I/O operation).

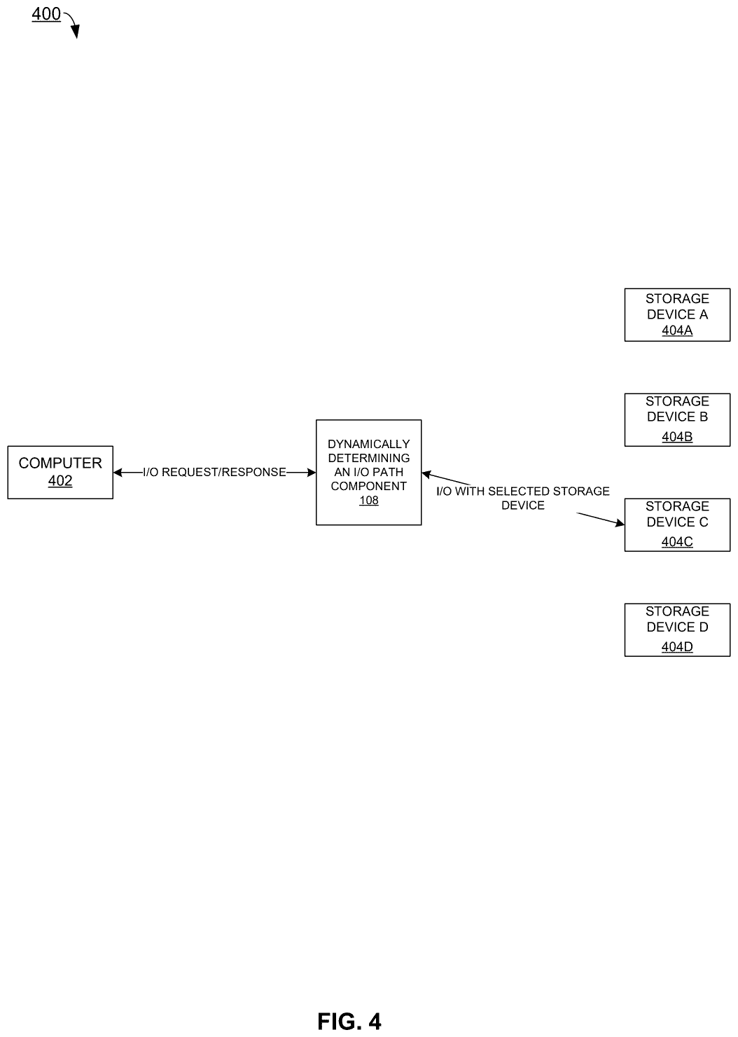

FIG. 4 illustrates an example 400 of selecting a storage device among multiple storage devices for an I/O operation, and that can facilitate dynamically determining an I/O path, in accordance with an embodiment of this disclosure. In some examples, part(s) of example 400 can be implemented by part(s) of system architecture 100 of FIG. 1 to facilitate dynamically determining an I/O path.

Example 400 comprises computer 402, storage device A 404A, storage device B 404B, storage device C 404C, storage device D 404D, and dynamically determining an I/O path component 408 (which can be similar to dynamically determining an I/O path component 108 of FIG. 1).

In example 400, computer 402 makes a request to perform an I/O operation. Dynamically determining an I/O path component 408 analyzes this request, determines that each of storage device A 404A, storage device B 404B, storage device C 404C, and storage device D 404D can service this request (e.g., determine that each of these storage devices stores data that is requested to be read), and select storage device C 404C for servicing this request, because it is the fastest storage device for read I/O among these four storage devices.

### Example Process Flows

FIG. 5 illustrates an example process flow for updating a mapping between respective storage locations and respective I/O performances of those storage devices according to a timer, and that can facilitate dynamically determining an I/O path, in accordance with an embodiment of this disclosure. In some examples, one or more embodiments of process flow 500 can be implemented by system architecture 100 of FIG. 1, or computing environment 1100 of FIG. 11.

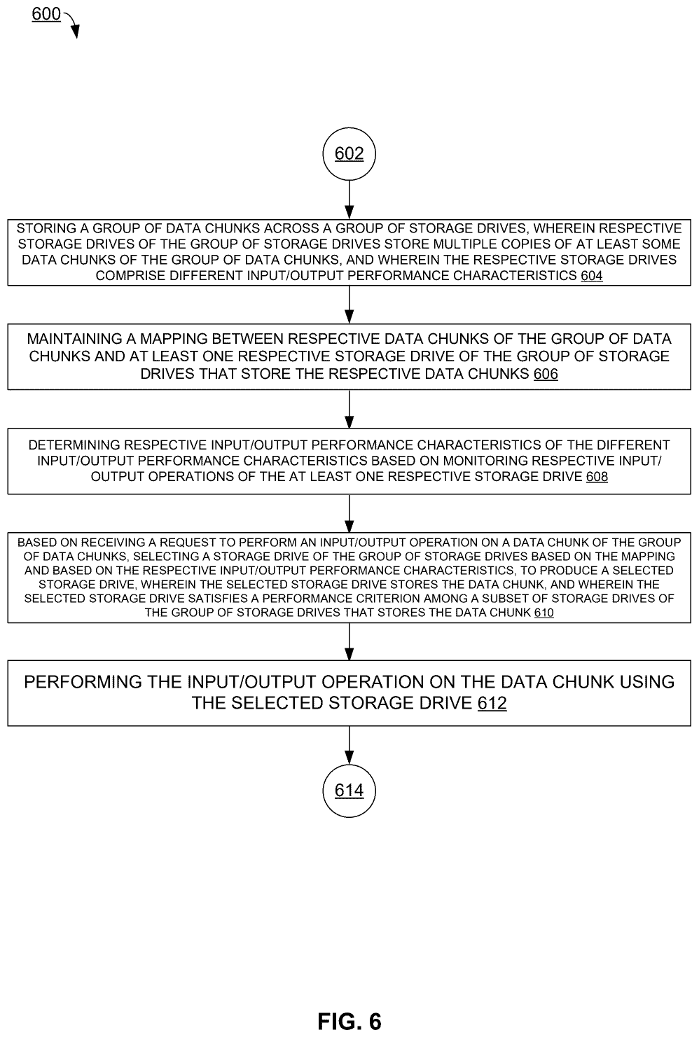

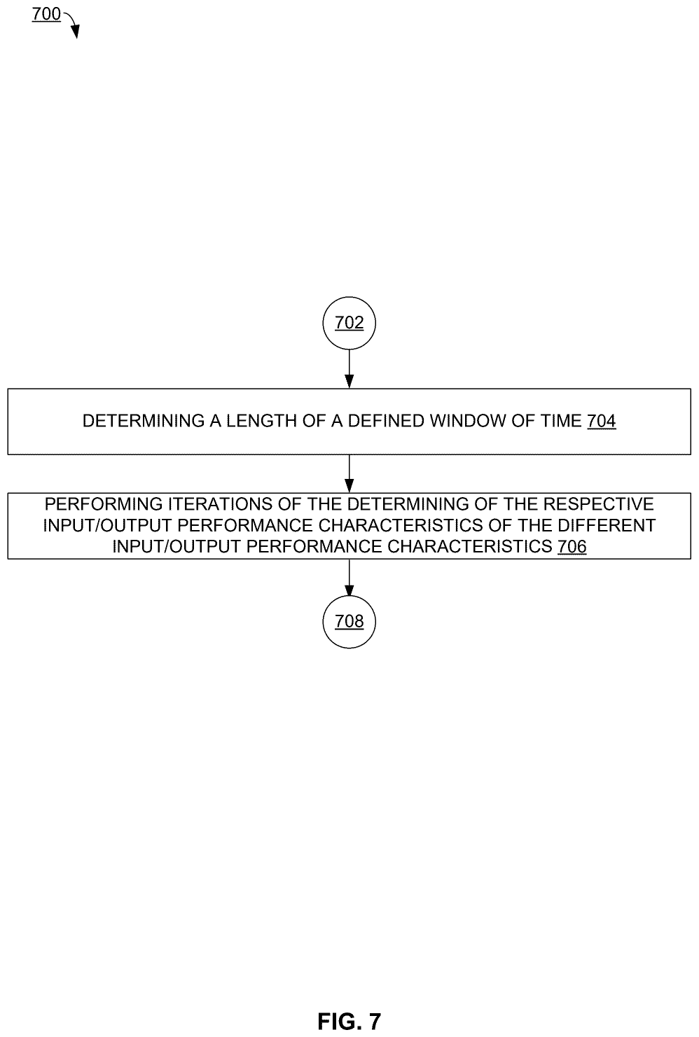

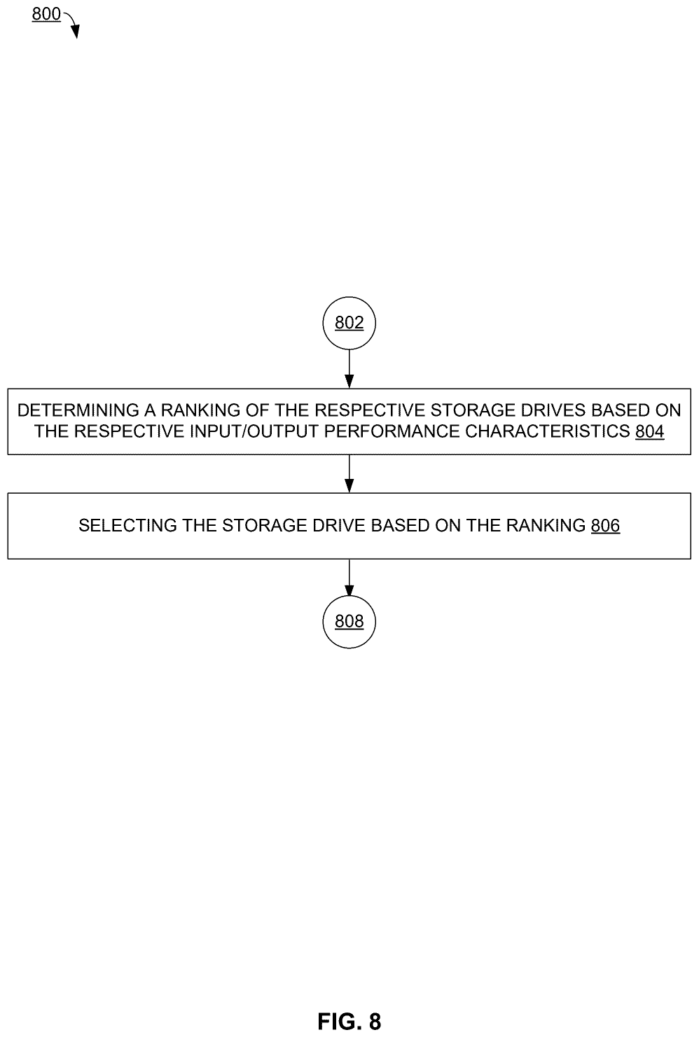

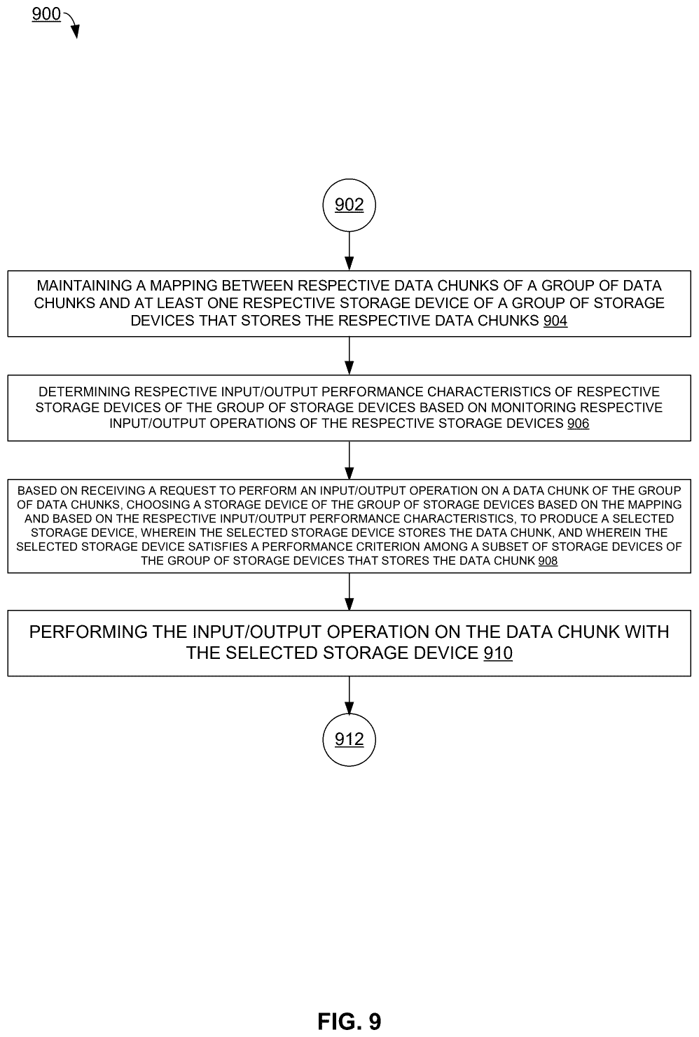

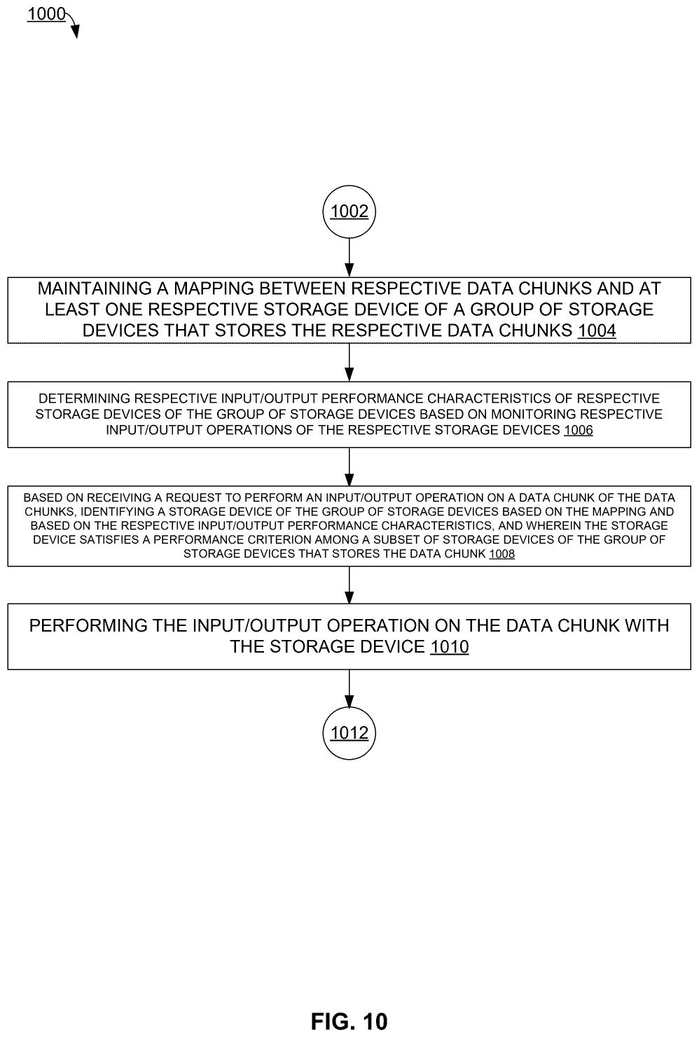

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of process flow 600 of FIG. 6, process flow 700 of FIG. 7, process flow 800 of FIG. 8, process flow 900 of FIG. 9, and/or process flow 1000 of FIG. 10.

Process flow 500 begins with 502, and moves to operation 504.

Operation 504 depicts measuring I/O performance. This can comprise measuring per-storage device performance for reads and/or writes for a specified amount of time (e.g., 5 minutes). The performance can be a metric such as average read speed, or average write speed.

After operation 504, process flow 500 moves to operation 506.

Operation 506 depicts updating the mapping. This can be the mapping in table 302 of FIG. 3 that captures performance metrics for different drives. As part of this, table 352 (the ranking of performance metrics) can also be updated.

After operation 506, process flow 500 moves to operation 508.

Operation 508 depicts determining whether a timer has expired. Where in operation 508 it is determined that the timer has expired, process flow 500 can return to operation 504. In this manner, performance measurements and rankings can be periodically updated, and a latest performance measurements and rankings can be used in determining which storage device to use to service an I/O request.

Where in operation 508 it is determined that the timer has not expired, process flow 500 can stay at operation 508 until it is determined that the timer has expired.

FIG. 6 illustrates an example process flow 600 that can facilitate dynamically determining an I/O path, in accordance with an embodiment of this disclosure. In some examples, one or more embodiments of process flow 600 can be implemented by system architecture 100 of FIG. 1, or computing environment 1100 of FIG. 11.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of process flow 500 of FIG. 5, process flow 700 of FIG. 7, process flow 800 of FIG. 8, process flow 900 of FIG. 9, and/or process flow 1000 of FIG. 10.

Process flow 600 begins with 602, and moves to operation 604.

Operation 604 depicts storing a group of data chunks across a group of storage drives, wherein respective storage drives of the group of storage drives store multiple copies of at least some data chunks of the group of data chunks, and wherein the respective storage drives comprise different input/output performance characteristics. Using the example of FIG. 1, this can comprise computer data stored on storage devices 110.

After operation 604, process flow 600 moves to operation 606.

Operation 606 depicts maintaining a mapping between respective data chunks of the group of data chunks and at least one respective storage drive of the group of storage drives that store the respective data chunks. Continuing with the example of FIG. 1, this can comprise storage mapping 112.

After operation 606, process flow 600 moves to operation 608.

Operation 608 depicts determining respective input/output performance characteristics of the different input/output performance characteristics based on monitoring respective input/output operations of the at least one respective storage drive. Continuing with the example of FIG. 1, this can comprise information that is stored in I/O metrics 114 and/or storage device ranking 116.

In some examples, the different input/output performance characteristics comprise first performance characteristics of read operations and second performance characteristics of write operations. In some examples, a first ranking of the respective storage drives based on the first performance characteristics of the read operations differs from a second ranking of the respective storage drives based on the second performance characteristics of the write operations. That is, there can be separate performance characteristics for read and for write operations for storage devices, and drives' relative performance for reads and for writes can differ.

After operation 608, process flow 600 moves to operation 610.

Operation 610 depicts, based on receiving a request to perform an input/output operation on a data chunk of the group of data chunks, selecting a storage drive of the group of storage drives based on the mapping and based on the respective input/output performance characteristics, to produce a selected storage drive, wherein the selected storage drive stores the data chunk, and wherein the selected storage drive satisfies a performance criterion among a subset of storage drives of the group of storage drives that stores the data chunk. That is, a fastest (or sufficiently fast) storage drive for a particular I/O operation can be selected.

In some examples, the performance criterion indicates that the selected storage drive has a fastest speed for the input/output operation among the subset of storage drives. That is, it can be that the fastest storage device for a particular operation can be selected.

After operation 610, process flow 600 moves to operation 612.

Operation 612 depicts performing the input/output operation on the data chunk using the selected storage drive. This can comprise performing the I/O operation on the storage device selected in operation 610.

After operation 612, process flow 600 moves to 614, where process flow 600 ends.

FIG. 7 illustrates another example process flow 700 that can facilitate dynamically determining an I/O path, in accordance with an embodiment of this disclosure. In some examples, one or more embodiments of process flow 700 can be implemented by system architecture 100 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of process flow 500 of FIG. 5, process flow 600 of FIG. 6, process flow 800 of FIG. 8, process flow 900 of FIG. 9, and/or process flow 1000 of FIG. 10.

Process flow 700 begins with 702, and moves to operation 704.

Operation 704 depicts determining a length of a defined window of time. This can be determined based on user input data. This defined window of time can be an amount of time in the past for which performance statistics will be measured—e.g., the prior five minutes—or an amount of time for which performance statistics will be measured before another iteration of measuring statistics will be performed.

After operation 704, process flow 700 moves to operation 706.

Operation 706 depicts performing iterations of the determining of the respective input/output performance characteristics of the different input/output performance characteristics. In some examples, the iterations of the determining of the respective input/output performance characteristics of the different input/output performance characteristics are performed for the defined window of time.

That is, the performance statistics can be iteratively determined so that they are relatively current at a given point in time.

After operation 706, process flow 700 moves to 708, where process flow 700 ends.

FIG. 8 illustrates another example process flow 800 that can facilitate dynamically determining an I/O path, in accordance with an embodiment of this disclosure. In some examples, one or more embodiments of process flow 800 can be implemented by system architecture 100 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of process flow 500 of FIG. 5, process flow 600 of FIG. 6, process flow 700 of FIG. 7, process flow 900 of FIG. 9, and/or process flow 1000 of FIG. 10.

Process flow 800 begins with 802, and moves to operation 804.

Operation 804 depicts determining a ranking of the respective storage drives based on the respective input/output performance characteristics.

In some examples, operation 804 comprises iteratively updating the ranking. This can be performed over time so that a current ranking is available, and can be done, for example, when performance statistics are updated.

After operation 804, process flow 800 moves to operation 806.

Operation 806 comprises selecting the storage drive based on the ranking.

In some examples, selecting the storage drive is performed based on identifying the selected storage drive in the ranking as having a highest ranking among the subset of storage drives of the group of storage drives that store the data chunk.

After operation 806, process flow 800 moves to 808, where process flow 800 ends.

FIG. 9 illustrates another example process flow 900 that can facilitate dynamically determining an I/O path, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow 500 of FIG. 5, process flow 600 of FIG. 6, process flow 700 of FIG. 7, process flow 800 of FIG. 8, and/or process flow 1000 of FIG. 10.

Process flow 900 begins with 902, and moves to operation 904.

Operation 904 depicts maintaining a mapping between respective data chunks of a group of data chunks and at least one respective storage device of a group of storage devices that stores the respective data chunks. In some examples, operation 904 can be implemented in a similar manner as operations 604-606 of FIG. 6.

In some examples, the at least one respective storage device of the group of storage devices that stores the respective data chunks of the mapping comprises respective locations within the at least one storage devices where the respective data chunks are stored. In some examples, the respective locations comprise respective node identifiers, respective device identifiers, and respective offsets. This can be similar to that which is depicted in FIG. 2.

After operation 904, process flow 900 moves to operation 906.

Operation 906 depicts determining respective input/output performance characteristics of respective storage devices of the group of storage devices based on monitoring respective input/output operations of the respective storage devices. In some examples, operation 906 can be implemented in a similar manner as operation 608 of FIG. 6.

After operation 906, process flow 900 moves to operation 908.

Operation 908 depicts, based on receiving a request to perform an input/output operation on a data chunk of the group of data chunks, choosing a storage device of the group of storage devices based on the mapping and based on the respective input/output performance characteristics, to produce a selected storage device, wherein the selected storage device stores the data chunk, and wherein the selected storage device satisfies a performance criterion among a subset of storage devices of the group of storage devices that stores the data chunk. In some examples, operation 908 can be implemented in a similar manner as operation 610 of FIG. 6.

After operation 908, process flow 900 moves to operation 910.

Operation 910 depicts performing the input/output operation on the data chunk with the selected storage device. In some examples, operation 910 can be implemented in a similar manner as operation 612 of FIG. 6.

In some examples, the data chunk is a first data chunk, and operation 910 comprises updating the mapping based on writing a second data chunk to the group of storage devices that does not store the second data chunk prior to performing the writing, wherein the second data chunk comprises the first data chunk or another data chunk other than the first data chunk. That is, the mapping can be updated when a chunk is written to a new storage device.

In some examples the data chunk is a first data chunk, the storage device is a first storage device, and operation 910 comprises updating the mapping based on removing a second data chunk from a second storage device of the group of storage devices, wherein the second storage device comprises the first storage device or another storage device, and wherein the second data chunk comprises the first data chunk or another data chunk. That is, the mapping can be updated when a chunk is deleted from a storage device.

After operation 910, process flow 900 moves to 912, where process flow 900 ends.

FIG. 10 illustrates another example process flow 1000 that can facilitate dynamically determining an I/O path, in accordance with an embodiment of this disclosure. In some examples, one or more embodiments of process flow 1000 can be implemented by system architecture 100 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of process flow 500 of FIG. 5, process flow 600 of FIG. 6, process flow 700 of FIG. 7, process flow 800 of FIG. 8, and/or process flow 900 of FIG. 9.

Process flow 1000 begins with 1002, and moves to operation 1004.

Operation 1004 depicts maintaining a mapping between respective data chunks and at least one respective storage device of a group of storage devices that stores the respective data chunks. In some examples, operation 1004 can be implemented in a similar manner as operations 604-606 of FIG. 6.

After operation 1004, process flow 1000 moves to operation 1006.

Operation 1006 depicts determining respective input/output performance characteristics of respective storage devices of the group of storage devices based on monitoring respective input/output operations of the respective storage devices. In some examples, operation 1006 can be implemented in a similar manner as operation 608 of FIG. 6.

In some examples, the respective input/output performance characteristics comprise performance characteristics of read operations. In some examples, the respective input/output performance characteristics comprise respective average speeds of the read operations. In some examples, the respective input/output performance characteristics comprise performance characteristics of write operations. In some examples, the respective input/output performance characteristics comprise respective average speeds of the write operations.

After operation 1006, process flow 1000 moves to operation 1008.

Operation 1008 depicts, based on receiving a request to perform an input/output operation on a data chunk of the data chunks, identifying a storage device of the group of storage devices based on the mapping and based on the respective input/output performance characteristics, and wherein the storage device satisfies a performance criterion among a subset of storage devices of the group of storage devices that stores the data chunk. In some examples, operation 1008 can be implemented in a similar manner as operation 610 of FIG. 6.

After operation 1008, process flow 1000 moves to operation 1010.

Operation 1010 depicts performing the input/output operation on the data chunk with the storage device. In some examples, operation 1010 can be implemented in a similar manner as operation 612 of FIG. 6.

After operation 1010, process flow 1000 moves to 1012, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of computer system 102 and/or user computer 106 of FIG. 1.

In some examples, computing environment 1100 can implement one or more embodiments of the process flows of FIGS. 5-10 to facilitate dynamically determining an I/O path.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system, comprising:
at least one processor; and
at least one memory that stores executable instructions that, when executed by the at least one processor, facilitate performance of operations, comprising:
storing a group of data chunks across a group of storage drives, wherein respective storage drives of the group of storage drives store multiple copies of a same data chunk of the group of data chunks, and wherein the respective storage drives comprise different read performance characteristics;
maintaining a mapping between respective data chunks of the group of data chunks and at least one respective storage drive of the group of storage drives that store the respective data chunks;
determining respective read performance characteristics of the different read performance characteristics based on monitoring respective read operations of the at least one respective storage drive;
based on receiving a request to perform a read operation on a data chunk of the group of data chunks, wherein the request itself does not specify a storage drive of the group of storage drives with which to perform the input operation,
identifying a subset of storage drives of the group of storage drives that are configured to serve the read operation,
based on the mapping,
selecting a storage drive of the subset of storage drives based on the respective read performance characteristics of the subset of storage drives, to produce a selected storage drive,
wherein the selected storage drive stores the data chunk, and wherein the selected storage drive satisfies a best performance criterion among a subset of storage drives of the group of storage drives that stores the data chunk; and
performing the read operation on the data chunk using the selected storage drive.

2. The system of claim 1, wherein the operations further comprise:
performing iterations of the determining of the respective read performance characteristics of the different read performance characteristics.

3. The system of claim 2, wherein the iterations of the determining of the respective read performance characteristics of the different read performance characteristics are performed for a defined window of time.

4. The system of claim 3, wherein the operations further comprise:
determining a length of the defined window of time based on user input data.

5. The system of claim 1, wherein the different read performance characteristics comprise first performance characteristics of read operations and second performance characteristics of write operations.

6. The system of claim 5, wherein a first ranking of the respective storage drives based on the first performance characteristics of the read operations differs from a second ranking of the respective storage drives based on the second performance characteristics of the write operations.

7. The system of claim 1, wherein the performance criterion indicates that the selected storage drive has a fastest speed for the read operation among the subset of storage drives.

8. The system of claim 1, wherein operations further comprise:
determining a ranking of the respective storage drives based on the respective read performance characteristics, and
wherein the selecting of the storage drive is performed based on the ranking.

9. The system of claim 8, wherein the operations further comprise:
iteratively updating the ranking.

10. The system of claim 8, wherein the selecting of the storage drive is performed based on identifying the selected storage drive in the ranking as having a highest ranking among the subset of storage drives of the group of storage drives that store the data chunk.

11. A method, comprising:
maintaining, by a system comprising at least one processor, a mapping between respective data chunks of a group of data chunks and at least one respective storage device of a group of storage devices that stores the respective data chunks;
determining, by the system, respective read performance characteristics of respective storage devices of the group of storage devices based on monitoring respective read operations of the respective storage devices;
based on receiving a request to perform an read operation on a data chunk of the group of data chunks, wherein the request itself fails to specify a storage drive of the group of storage devices with which to perform the input operation,
identifying, by the system, a subset of storage devices of the group of storage devices that are configured to serve the read operation, and
choosing, by the system, a storage device of the subset of storage devices based on the mapping and based on the respective read performance characteristics of the subset of storage devices, to produce a selected storage device, wherein the selected storage device stores the data chunk, and wherein the selected storage device satisfies a performance criterion among a subset of storage devices of the group of storage devices that stores the data chunk; and
performing, by the system, the read operation on the data chunk with the selected storage device.

12. The method of claim 11, wherein the data chunk is a first data chunk, and further comprising:
updating, by the system, the mapping based on writing a second data chunk to the group of storage devices that does not store the second data chunk prior to performing the writing, wherein the second data chunk comprises the first data chunk or another data chunk other than the first data chunk.

13. The method of claim 11, wherein the data chunk is a first data chunk, wherein the storage device is a first storage device, and further comprising:
updating, by the system, the mapping based on removing a second data chunk from a second storage device of the group of storage devices, wherein the second storage device comprises the first storage device or another storage device, and wherein the second data chunk comprises the first data chunk or another data chunk.

14. The method of claim 11, wherein the at least one respective storage device of the group of storage devices that stores the respective data chunks of the mapping comprises respective locations within the at least one storage devices where the respective data chunks are stored.

15. The method of claim 14, wherein the respective locations comprise respective node identifiers, respective device identifiers, and respective offsets.

16. A non-transitory computer-readable medium comprising instructions that, in response to execution, cause a system comprising at least one processor to perform operations, comprising:
maintaining a mapping between respective data chunks and at least one respective storage device of a group of storage devices that stores the respective data chunks;
determining respective input performance characteristics of respective storage devices of the group of storage devices based on monitoring respective input operations of the respective storage devices;
based on receiving a request to perform an input operation on a data chunk of the data chunks, wherein the request is silent as to a storage drive of the group of storage drives with which to perform the input operation,
identifying a subset of storage devices of the group of storage drives that store a copy of the data chunk,
identifying a storage device of the subset of storage devices based on the mapping and based on the respective read performance characteristics, and wherein the storage device satisfies a performance criterion among the subset of storage devices; and
performing the input operation on the data chunk with the storage device.

17. The non-transitory computer-readable medium of claim 16, wherein the respective read performance characteristics comprise performance characteristics of read operations.

18. The non-transitory computer-readable medium of claim 17, wherein the respective read performance characteristics comprise respective average speeds of the read operations.

19.-20. (canceled)

21. The non-transitory computer-readable medium of claim 16, wherein the identifying of the subset of storage devices that are configured to serve the read operation is based on determining that each storage device of the subset of storage devices stores the copy of the data chunk.

21. The system of claim 1, wherein the identifying of the subset of storage drives of the group of storage drives that are configured to serve the read operation is based on determining that each storage drive of the subset of storage drives stores a copy of the data chunk.
